(19) United States
(12) Patent Application Publication
(10) Pub. No.: US 2024/0168504 A1
(43) Pub. Date: May 23, 2024

(54) Adaptive Control of a Heating Apparatus Based on a Load's Thermal Properties

(71) Applicant: Samsung Electronics Co., Ltd., Suwon-si (KR)

(72) Inventors: Musa Maharramov, The Woodlands, TX (US); Brian Patton, San Francisco, CA (US); Pedro Martinez Lopez, Mountain View, CA (US); Nigel Clarke, Mountain View, CA (US)

(21) Appl. No.: 17/984,454

(22) Filed: Nov. 10, 2022

(51) Int. Cl. G05D 23/27; A23L 3/365; A23L 5/10; G01J 5/48; G05B 13/04; H05B 6/64

(52) U.S. Cl. CPC G05D 23/27; A23L 3/365; A23L 5/15; G01J 5/485; G05B 13/048; H05B 6/645; G01J 2005/0077

(57) ABSTRACT

In one embodiment, a method includes accessing a temperature map of a food item in a cooking apparatus, where the temperature map comprises a plurality of regions of the food item and associates a temperature with each region, and the cooking apparatus cooks according to an initial heating technique. The method includes determining, by a computing device, whether a temperature associated with at least one region of the food item violates a predetermined temperature constraint, and in response to a determination that the temperature associated with at least one region of the food item violates a predetermined temperature constraint, then determining an optimal heating technique and instructing the cooking apparatus to cook according to the optimal heating technique. In response to a determination that the temperature of each region does not violate a predetermined temperature constraint, the method includes determining that the initial heating technique should not be changed.

### TECHNICAL FIELD

This application generally relates to adaptively controlling a heating apparatus based on a load's thermal properties.

### BACKGROUND

Cooking appliances, such as microwave ovens, kitchen ranges such as gas or electric ranges, toaster ovens, and air fryers, all cook according to fixed or preset controls of cooking variables (e.g., time, power) for the cooking process. For example, a microwave oven may require the user to input a time setting (e.g., how long to cook the food) and a power setting, while a range may require the user to input a temperature setting and then independently monitor the length of cooking time. A cooking appliance may also permit users to select a preset entry, which corresponds to preset time and power settings. For example, a user may select a preset type of food and a weight or quantity of the food, and then the cooking appliance looks up corresponding power and time values to control the cooking process. Based on the user's inputs, the cooking appliance cooks according to the predetermined values for time, power, and/or temperature.

Fixed or preset control of cooking variables often results in suboptimal cooking (such as over-cooking or under-cooking food), in part due to the wide variability of the food (ingredients, density, etc.). These kinds of controls also require user intervention (e.g. the user has to check a pizza multiple times to avoid it getting burned) to monitor the cooking process. For example, in a microwave oven, a user may stop the microwave because the user notices food splatter while reheating leftovers. In another scenario, a user may have to add more time because the leftovers were too cold after the initial heating time finished. In another scenario, a frozen food item may be partially cooked and partially frozen because the preset controls cooked both too hot and for not enough time.

### BRIEF DESCRIPTION OF THE DRAWINGS

FIG. 1 illustrates an example method of adaptively and automatically controlling a cooking apparatus based on a food item's thermal properties.

FIG. 2 illustrates an example temperature map of a food item.

FIGS. 3A and 3B illustrates an example of steps 130 and 140 of the example of FIG. 1.

FIG. 4 illustrates an example temperature graph of the cooking process corresponding to FIGS. 3A and 3B.

FIG. 5 illustrates another example procedure for adaptively and automatically controlling a cooking apparatus based on a food item's thermal properties.

FIG. 6 illustrates an example heat-exchanger model.

FIG. 7 illustrates an example computing device.

### DESCRIPTION OF EXAMPLE EMBODIMENTS

Uneven heating is a common issue in both consumer and commercial thermal processing systems such as a cooking apparatus. Multiple factors impact temperature heterogeneity within a load (i.e., the food): these factors include geometry and thermal properties of the load, as well as design features and operational constraints of the apparatus. As an example, sharp corners in food tend to overheat during microwave heating due to internal reflections and focusing of the RF energy, and the inherent standing-wave pattern set up in a microwave oven further contributes to uneven heating. Thawing of frozen foods in microwave ovens is one example of this problem: the corners or edges of the food can easily be overheated or parcooked before the bulk of the food is fully thawed.

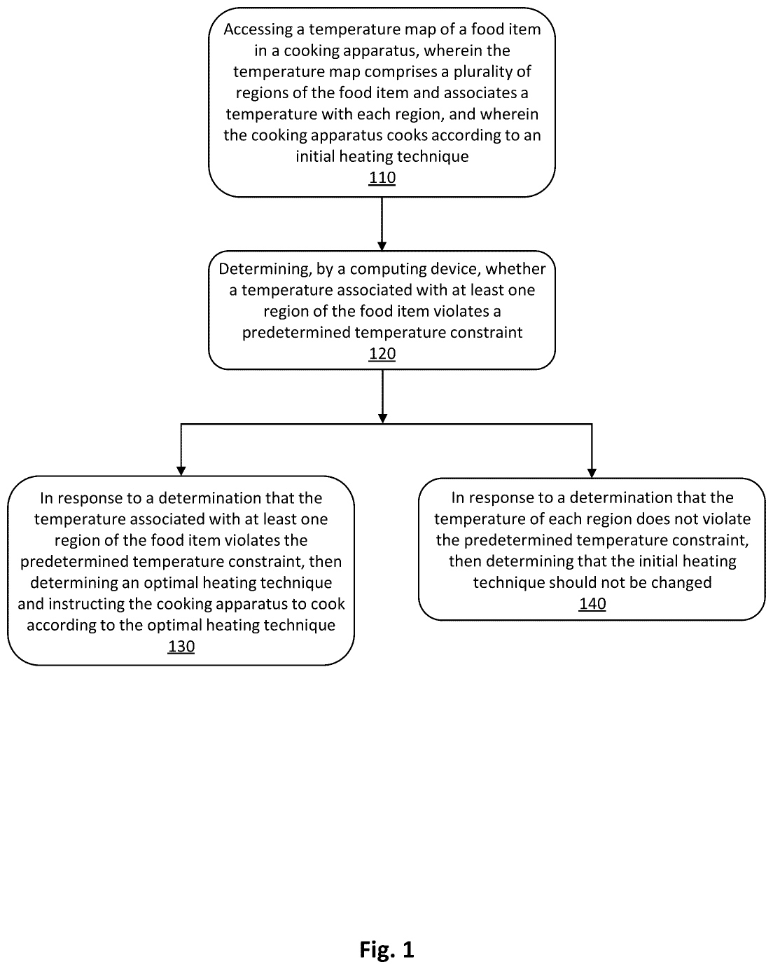

FIG. 1 illustrates an example method of adaptively and automatically controlling a cooking apparatus based on a food item's thermal properties. Temperature is one example of a food item's thermal properties; other examples include thermal conductivity and thermal diffusion rate. Step 110 of the example method of FIG. 1 includes accessing a temperature map of a food item in a cooking apparatus, where the temperature map includes a plurality of regions of the food item and associates a temperature with each region, and where the cooking apparatus cooks according to an initial heating technique. A cooking apparatus may include a cooking appliance, such as a microwave or an oven; however, the techniques and disclosure provided herein may also be used for other heating equipment and processes, such as for example in industrial thermal processing equipment and/or medical or sanitary thermal processing equipment (e.g., therapeutic microwave irradiation in medicine).

In particular embodiments, the temperature map may be accessed by a computing device (e.g., a processor and memory) integrated with the cooking apparatus. In particular embodiments, the temperature map may be accessed from a separate computing device, such as for example from a client computing device (e.g., a smartphone, laptop, etc.) or from a server device. In particular embodiments, accessing a temperature map includes creating the temperature map. This disclosure contemplates any suitable approach for creating a temperature map of a food item in a cooking apparatus. For example, a temperature map may be created by one or more thermal images from one or more thermal cameras with a field of view that includes the interior of the cooking apparatus, such as a thermal camera that is integrated within the cooking apparatus. In particular embodiments, a temperature map may be a two-dimensional temperature map, such as for example a surface map of the food item. In particular embodiments, a temperature map may include three-dimensional information, such as for example temperature measurements from the surface of the food item and temperature measurements from the interior of the food item.

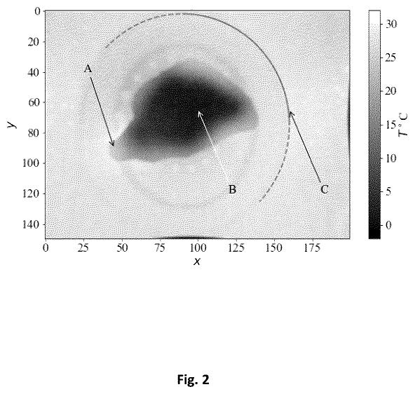

In particular embodiments, the regions of the food item that are associated with a temperature may be each pixel in a thermal image of the food item. As illustrated in this example, a temperature may be associated with each of the smallest discernable unit of food item, according to the technique used to generate the temperature map. In particular embodiments, a region may be a larger size, such as for example a collection of pixels in thermal image. Each region is associated with a particular temperature, and in most cooking scenarios, the temperature of a food item is not homogenous during the cooking process. For example, FIG. 2 illustrates an example temperature map of a food item (in this case, a tuna steak) in a microwave oven after cooking for a period of time. As illustrated in FIG. 2, the tuna steak's temperature is not homogenous. For example, point B, near the center of the tuna steak, is still frozen, while Point A, which is a relatively narrow, sharp corner of the tuna steak, is at a much higher temperature. Moreover, some of the unevenness in the cooking of the tuna steak is due to that fact that the plate, indicated by point C in FIG. 2, is at a much higher temperature than the tuna steak, and as a result point A is receiving more heat from its immediate surroundings than is point B.

In the example of FIG. 1, the cooking apparatus initially cooks according to an initial heating technique. The heating technique is a set of one or more cooking variables (e.g., time, power settings or flame-level settings, cooking mode, etc.) that define at least in part how cooking will proceed. As explained more fully below, a heating technique may include fixed values for the cooking variables (e.g., heat at power level 7 for 2 minutes) or may include variable values (e.g., heat at power level 7 until a certain condition is met and then heat at power level 3 until another condition is met). In particular embodiments, an initial heating technique may be predetermined or preset. For example, an initial heating technique for a microwave may be full power, based on the assumption that food is initially far from the desired final temperature. In particular embodiments, an initial heating technique may depend on the particular cooking apparatus, on the particular use-case (e.g., as indicated by user input) of that cooking apparatus, or on one or more detected features about the cooking scenario. For example, a bottle warmer may initially heat at a low temperature while a microwave may initially heat at a maximum temperature. As another example, a convection oven may initially heat at high convection if the user specifically selects a “fry” or “crisp” or similar setting. As another example, an initial heating technique may initially be a relatively low power if the user selects a “warm” setting and the food item (e.g., as sensed by a thermal camera) is already at room temperature.

Step 120 of the example method of FIG. 1 includes determining, by a computing device, whether a temperature associated with at least one region of the food item violates a predetermined temperature constraint. This determination may be made on a subsequently accessed or created temperature map. For example, a subsequent thermal image (i.e., a thermal image after some cooking according to the initial heating technique has occurred) may be obtained of the food item, and a temperature map of the surface of the food item may be created. Therefore, in this example step 120 includes determining from the temperature map whether a temperature associated with part of the food (e.g., a temperature associated with a pixel identified as being part of the food item or associated with a group of pixels identified as being part of the food item) exceeds a predetermined temperature constraint. For example, a temperature constraint may be a maximum temperature, a minimum temperature, or an average temperature of multiple regions of the food item. As explained herein, a temperature constraint may be associated with a predicted temperature of a corresponding region of the food item.

While step 120 of the example of FIG. 1 involves determining whether at least one region of the food item violates a predetermined temperature constraint, this disclosure contemplates that a similar determination may be made regarding one or more other thermal constraints. For example, a determination may be made as to whether at least one region of the food item violates a predetermined heating-rate constraint, a thermal-diffusion constraint, a browning-level constraint, a consistency (e.g., viscosity) constraint, a phase (e.g., solid-liquid-gas) constraint, a geometry constraint (changing shape or dimensions), or a weight constraint (e.g. due to evaporation) etc.

In particular embodiments, the value of a predetermined constraint may be based on one or more of a cooking procedure, the goals for the cooking procedure, or user inputs regarding the cooking procedure. For example, if the predetermined temperature constraint is a maximum temperature, a “sear” setting (e.g., associated with an oven or grill) may be associated with a higher predetermined temperature than a “boil” setting (e.g., associated with a microwave), which may be associated with a higher predetermined temperature than a “warm” setting, which may be associated with a higher predetermined temperature than a “defrost” setting. In particular embodiments, the value of a predetermined thermal constraint may be based on an identification of a food item, for example based on the volume, weight, or type of food item. In particular embodiments, a user may specify or adjust the value of a predetermined thermal constraint. For example, a user may specify a value of a thermal constraint for a “warm” or “defrost” setting based on the user's cooking preferences.

Step 130 of the example method of FIG. 1 includes in response to a determination that the temperature associated with at least one region of the food item violates the predetermined temperature constraint, then determining an optimal heating technique and instructing the cooking apparatus to cook according to the optimal heating technique. Step 140 of the example method of FIG. 1 includes in response to a determination that the temperature of each region does not violate the predetermined temperature constraint, then determining that the initial heating technique should not be changed. In each instance, the determination may be made based on a violation of one predetermined temperature constraints or on more than one violation of a predetermined temperature constraint, or of multiple different predetermined temperature constraints.

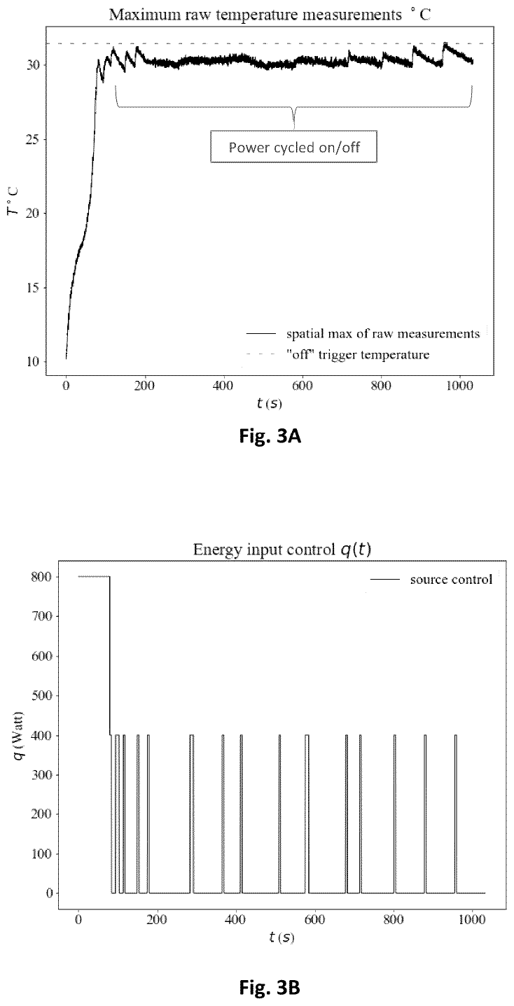

FIGS. 3A and 3B illustrates an example of steps 130 and 140 of the example of FIG. 1. FIG. 3A illustrates the maximum temperature, as a function of time, of a food item being defrosted in a microwave. In the example of FIG. 3A, the predetermined thermal constraint is a maximum temperature of about 32 degrees Celsius. FIG. 3B illustrates a corresponding power output of the microwave as a function of time. In the example of FIGS. 3A and 3B, the initial heating technique may be a certain power (e.g., 800 watts), which may be the maximum power level of the microwave. Heating at this power level continues until a region (or a predetermined number of regions) of the food item reaches or exceeds the predetermined maximum temperature constraint. In response to this determination, the microwave begins heating at an optimal heating technique, which in the example of FIGS. 3A and 3B, means that the power level immediately drops to 0 watts, i.e., the cooking apparatus stops introducing heat to the system. Once the maximum temperature of the food item falls below a certain temperature, e.g., approximately 30 degrees Celsius in the example of FIG. 3B, then the heating may continue at 400 watts, again until the predetermined maximum temperature is reached. In this example, heating at 400 watts or at 0 watts (i.e., the optimal heating technique, in this example) continues based on the maximum temperature of the food item until the defrosting process is complete. As explained above, the specific cycling shown in FIG. 3B cannot effectively be used as a preprogrammed heating cycle, as its ability to heat food without overcooking is ultimately based on the specific food item used and its thermal properties, including its shape, size, density, conductivity, etc. Using the heating pattern shown in FIG. 3B for a different food item, even if of the same type, will have a different thermal result, and therefore effective heating control in this disclosure is based on monitoring the food item's thermal properties.

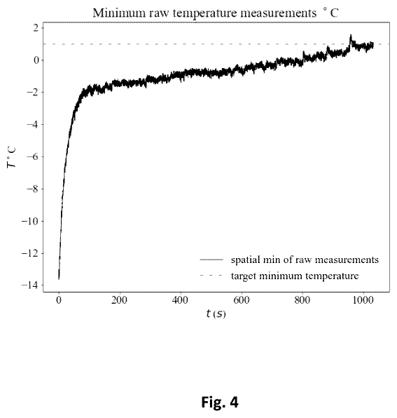

In particular embodiments, a process of adaptively and automatically controlling a cooking apparatus based on a food item's thermal properties, such as the example method of FIG. 1, may continue until a predetermined thermal constraint is reached, and which point the cooking process may be completed and the cooking apparatus may be turned off (or, for example, set to a “warming” mode). In particular embodiments, this predetermined thermal constraint may be a predetermined target temperature of the food item, and thus the process may continue until the target temperature of the food item is reached. In particular embodiments, the cooking process may complete when any portion of the food item reaches the predetermined target temperature. In particular embodiments, the cooking process may complete when all (or a predetermined percentage of, e.g., 95% of) a food item has reached the predetermined target temperature. For example, FIG. 4 illustrates an example temperature graph of the cooking process corresponding to FIGS. 3A and 3B. The temperature graph in FIG. 4 illustrates the minimum temperature of the food item as a function of time. In this example, heating of the food item is as shown in FIGS. 3A and 3B (which is based on the maximum temperature of the food item), while the continuation and completion of the overall defrosting process is determined by the minimum temperature of the food item. In the example of FIG. 4, which corresponds to defrosting food in the microwave, the minimum temperature threshold may be about 1 degree Celsius. As illustrated in FIG. 4, the defrosting process continues (e.g., the steps of the example of FIG. 1 may be iteratively or periodically performed) until the minimum temperature of the food item reaches the target minimum temperature (in particular embodiments, when the food item reaches at least that minimum temperature for a period of time, for example of account for measurement errors in the temperature map).

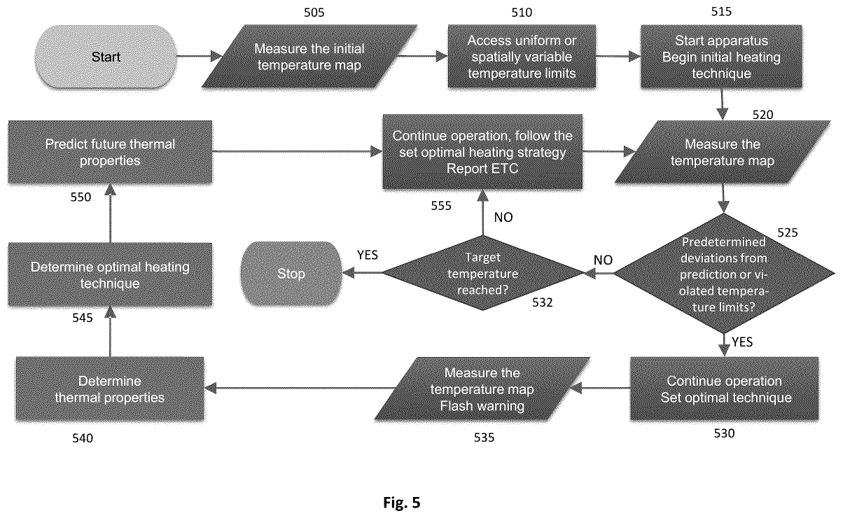

FIG. 5 illustrates another example procedure for adaptively and automatically controlling a cooking apparatus based on a food item's thermal properties. Embodiments of FIG. 5 may result in the techniques described in the examples illustrated in FIGS. 3A and 3B and FIG. 4.

At step 505, the example of FIG. 5 measures or accesses a temperature map, as described more fully above in connection with step 110 of FIG. 1. At step 510, the example of FIG. 5 may set or access temperature limits. These temperature limits are a specific example of limits, or thresholds, for thermal properties of a food item, and this disclosure contemplates that limits or thresholds for other thermal properties may be used in the process of FIG. 5 instead of or in addition to temperature limits. As illustrated in step 510 of FIG. 5, these limits may be uniform (i.e., may apply equally to all the food being heated in a cooking apparatus) or may vary, for example based on position. For example, if a load involved multiple different types of food, then each type of food may be associated with a particular temperature limit or other limit for a thermal property.

Step 515 of the example of FIG. 5 involves starting the cooking apparatus according to an initial heating technique, for example as described above in connection with step 110 of FIG. 1. As described above, an initial heating technique may be a predetermined temperature or power level associated with the cooking apparatus. As described below, a heating technique q may be a function of time and/or space. For example, the heating technique may involve varying the power of a cooking apparatus over time or may involve heating different portions (e.g., different burners on an oven or a grill) of the cooking apparatus by different amounts.

Step 520 of the example of FIG. 5 includes measuring or accessing, after some amount of cooking according to the initial heating technique, a subsequent temperature map of the food item. At step 525, and based on this subsequent temperature map, the example of FIG. 5 includes a decision block that determines whether either or both of (1) a temperature limit (or other thermal-property constraint or threshold, more broadly) is violated; or (2) whether one or more predicted thermal properties of the food item deviate from an actual thermal property or properties by a threshold amount (e.g., by a predetermined percentage amount, or absolute value amount, etc.). For example, step 525 may include determining whether a temperature of the food item (such as a maximum temperature of one or more regions of the food item) exceed a predetermined maximum temperature by a certain amount, or whether a predicted maximum temperature of the food items differs from an actual maximum temperature by a predetermined amount.

If the determinations in step 525 are negative, then at step 532 in the example of FIG. 5 a determination is made as to whether a target thermal condition, such as a target minimum temperature, of the food item is reached. This target condition may be set by a user of the cooking apparatus (e.g., a slider or other input may be provided on the cooking apparatus that lets the user specify whether they want to defrost or cook gently or quickly) or may be determined automatically, for example based on the cooking process (e.g., defrosting) being used or based on recognizing the type of food comprising the load. If the target condition has been reached, then the cooking apparatus may be turned off, or may be set to a non-cooking mode such as a “warming” mode. If the target condition has not been met, then at step 555 the process of FIG. 5 may continue operation according to the existing heating technique, which may be the initial heating technique or the optimal heating technique if one has been set in step 530 or step 545, as explained more fully herein. As explained below, step 555 may also include providing information to a user about the cooking process, such as one or more thermal conditions of the food item or an estimated time to completion (ETC) of the cooking process. For example, step 555 may include providing to a user (such as on a display of the cooking apparatus or, e.g., via a notification to a user's smartphone or smartwatch) an identification of the heating technique being used, the maximum or minimum food temperature, etc. The example of FIG. 5 may then return to step 520 and the process of FIG. 5 may continue until the stopping condition is met.

If a determination in step 525 is positive, then at step 530 the example of FIG. 5 includes setting an initial optimal heating technique. For example, as discussed above in connection with FIGS. 3A and 3B, an initial optimal heating technique may be pausing the heat introduced by the cooking apparatus. For example, the problem of partial overheating of food can be mitigated by reducing or pausing the applied heat when the system detects that some region of the food is too hot. During times of reduced heat influx, temperature inhomogeneities within the food are smoothed out by the process of thermal diffusion. In particular embodiments, an initial optimal heating technique may include reducing the power of the cooking apparatus by a certain amount or to a certain level.

Step 535 of the example of FIG. 5 includes measuring or accessing a temperature map of the food item in the cooking apparatus. Step 535 may include flashing or providing a warning to the user, for example on a display of the cooking apparatus or to a connected (e.g., via Wi-Fi, etc.) client computing device of the user.

In particular embodiments, such as the example of FIGS. 3A and 3B, a cooking process may monitor the temperature of the food item and adjust the heating technique accordingly. For example, as described with respect to the example of FIGS. 3A and 3B, if the maximum temperature of the food item falls below a certain threshold, then the optimal heating technique may be to resume heating at a particular amount, e.g., at 50% power. This monitoring and heating-technique adjustment process may continue until the stopping condition is reached.

In the example of FIG. 5, the cooking process determines the thermal properties of the food item to determine an optimal heating technique and, in some embodiments, to update the predicted thermal properties that are checked in, e.g., step 525 of FIG. 5. For example, step 540 of the example of FIG. 5 includes determining thermal properties of the food item. As explained more fully below, this may include estimating the thermal properties of the food item.

In particular embodiments, the heating process may be modeled using optimal control with a desired cost functional. For example, temperature or other operational constraints are incorporated as equality or inequality constraints within the solution of a thermal diffusion partial differential equation (PDE). A solution of this PDE yields spatial and temporal temperature profiles of the load (i.e., at least the food item, in this example, or another object to be heated in other thermal applications). Time-variable parameters that can be controlled in real time (such as heat influx) are specified as control variables. Relevant load-specific parameters may include load geometry, specific heat, thermal conductivity, density, state of matter, etc. As explained herein, unknown geometric and thermal properties of the load may be estimated or determined from visual, thermometric, weight, and other available measurements. Such measurements can be made during a cooking process. As explained below, parameter estimations can be made so that the techniques disclosed herein can be implemented on even low-power, low-cost computing devices. Then, combining the optimal control solution with the estimated immutable parameters results in an adaptive control algorithm (e.g., an optimal heating technique) to be implemented by the cooking apparatus.

As mentioned above, particular embodiments include estimation techniques that enable computers with limited computing power to utilize the techniques disclosed herein. For example, particular embodiments may use one or more heuristic or analytically-derived heat-source control strategies that are time-optimal or near-optimal in food processing applications. As another example, particular embodiments may discretize the thermal diffusion PDE and therefore reduce the complexity of both resource estimation and that of identifying optimal control strategy. As another example, particular embodiments may use a “heat exchanger” model that adequately describe the evolution of aggregate process parameters (such as, without limitation, minimum and maximum load temperatures) and allow efficient implementation on minimal process-control hardware.

Particular embodiments deterministically control certain heating parameters and measure temperature rise of the load to estimate its physical characteristics, then use those estimations when calculating a solution to the thermal diffusion PDE, yielding a predicted thermal evolution of the load. Optimization can then be used to calculate a control-parameter sequence that minimizes or maximizes a quantity of interest to the user, such as the total heating time or consumed energy. The results of the thermal diffusion model, predicated on the estimated physical properties of the load and presuming the optimal control sequence already calculated, yield an estimated time to completion that can be conveyed to the user, in particular embodiments. In particular embodiments, a simplified heat-exchanger model can be implemented in lieu of a full solution to the thermal diffusion equation to perform the determinations and estimations discussed in this paragraph.

To determine thermal properties of a load, particular embodiments use a time-dependent temperature distribution T≡T(t, x, y, z). To simplify the discussion herein, this disclosure discusses examples where the distribution is calculated based on a surface map, e.g., T≡T(t, x, y), that is governed by the following thermal diffusion PDE (equivalently, “heat equation”):

$$ρ ( T , x , y ) {c}_{p} ( T , x , y ) \frac{\partial T}{\partial t} = ∇ ( k ( T , x , y ) ∇ T ) + q ( t , x , y ) . \qquad ( 1 )$$

When using Eq. (1), any thickness variations of the load can be absorbed into the coefficients. Temperature distribution T=T(t, x, y) can be considered to be a “state variable,” while the energy source q=q(t, x, y) is a “control variable.” This energy source is time-dependent because we presume to have control over the input energy at any moment in the process, but the spatial dependence may be due to the immutable parameters of the load or of the cooking apparatus's design (e.g., regions of the food that heat up more quickly in the microwave, or RF inhomogeneity due to the standing-wave pattern). ∇T indicates the two-dimensional spatial gradient of the temperature distribution, and functions ρ(T, x, y), cₚ(T, x, y), k(T, x, y) are density, specific heat, and thermal conductivity, respectively. Note that particular embodiments allow for temperature dependence of the load's thermal parameters, which is generally the case in the problem of interest. For example, heat conductivity of ice is greater than that of water, and both phases are relevant to food processing applications.

Particular embodiments seek solutions T=T(t, x, y) to Eq. (1) in a two-dimensional (in this example) domain [symbol] ⊂ [symbol] ² (e.g., as delineated by boundary C) that satisfy initial and boundary-value conditions:

T(0,x,y)=T₀(x,y),(x,y)∈ [symbol] , (2)

[symbol]

∇T(t,x,y), [symbol] [symbol] [symbol] =0,(x,y)∈ [symbol] =∂ [symbol] , (3)

where equation (2) describes initial temperature distribution, and equation (3) describes zero heat flow along the boundary, and [symbol] [symbol] ⊥ [symbol] is the unit normal to the domain boundary. In particular embodiments, the boundary [symbol] may be a dish or plate in contact with the food item, and then equation (3) means that the heat flow between e.g., a microwave turntable or an oven dish and the surrounding air is significantly less than the heat flow between the turntable and the load or the dish and the load. Any suitable boundary conditions such as alternative Dirichlet, Neumann, or other local or non-local boundary conditions can be used as well or in the alternative.

Equations (1-3) represent a general physical description of thermal diffusion within a load given some observed initial conditions. The temperature distribution will follow these equations; the only approximations made to this point are the treatment of the food as two-dimensional and the presumption of no significant heat flow between the load and the air.

Particular embodiments introduce a cost function (sometimes called a “penalty function”) that the system or a user may wish to minimize. Examples include overall heating time, maximum deviation of the temperature from a target set point, total energy consumed, or entropy (which is akin to achieving a specific non-uniform temperature profile.) This disclosure contemplates that any function that the user or system wishes to maximize can be written as a complementary function to be minimized.

Particular embodiments minimize a cost function:

J=∫₀^{t}^{ₘₐₓ}∫∫ [symbol] F(T(t,x,y),q(t,x,y),ρ(T,x,y),cₚ(T,x,y),k(T,x,y),x,y,t)dxdy dt (4)

for an arbitrary function F, by controlling the energy source/drain q (t, x, y) subject to state variable (e.g., temperature) constraints:

Tₘᵢₙ(t,x,y)≤T(t,x,y)≤Tₘₐₓ(t,x,y),t∈[0,tₘₐₓ]) (5a)

T′ₘᵢₙ(x,y)≤T(tₘₐₓ,x,y)≤T′ₘₐₓ(x,y) (5b)

and control variable constraints:

qₘᵢₙ(t,x,y)≤q(t,x,y)≤qₘₐₓ(t,x,y),t∈[0,tₘₐₓ], (6)

where t is time and T is temperature. In Eqs. (4-6) tₘₐₓ is the maximum modeling time, and could be either fixed or unknown. Inequality (5a) expresses a constraint on the temperature profile for all times. As one simple example, this could simply be a constraint that no portion of the load exceeds a certain temperature Tₘₐₓ at any point in the heating process. Inequality (5b) expresses the termination criterion for the heating process—basically, at the end of the process, the temperature profile must fall within some desired constraint. As an example, this could simply express that the final temperature of the load should everywhere be within 1° C. of a uniform predetermined target temperature. Finally, inequality (6) expresses the limits of the heating that can be applied to the load over the course of the process. In particular embodiments qₘᵢₙ may be zero, because the controller can completely turn off the heat source. The maximum heating qₘₐₓ that can be applied is constrained by the cooking apparatus. Equation (4) describes the optimization problem used by particular embodiments, and Equations (5-6) describe the temperature and power constraints applied when finding the optimal control sequence.

Particular embodiments identify any parameters in equation (1) that can be known a priori and are independent of the load (for example, thermal and geometric properties of an oven or grill rack or turntable [symbol] ). Particular embodiments collect measurements of the initial conditions (2), then start operation of the apparatus, continuously or periodically measuring T(t, x, y). Particular embodiments vary the control q(t, x, y) within the constraints (6) to probe the boundary conditions (5), adaptively changing the control when the constraints (5) become active (e.g., become equality constraints). Once sufficient datapoints for T=T(t, x, y) have been collected, particular embodiments solve parameter estimation (“inverse”) problem for estimating a combination of ρ(T, x, y), cₚ(T, x, y), k(T, x, y) for the load (e.g., the food item). When all parameters in (1) except the control are known or thus estimated, particular embodiments solve the optimal control problem (1-6) with respect to q(t, x, y) with updated initial conditions. Particular embodiments may optionally stop operation of the cooking apparatus while the solution is in progress.

Once the desired control q(t, x, y) has been identified, particular embodiments solve equation (1) until the terminal conditions in (5) are satisfied, then report the resulting estimate of thermal conditions, such as J and/or tₘₐₓ, to the user. Operation of the cooking apparatus then continues under the control q(t, x, y).

Particular embodiments that use this approach rely on finding an exact or approximate solution to the thermal diffusion equation. There are many ways to achieve this, ranging from a full analytical solution to numerical computation. However, for many real-world applications, finding a full analytical solution or even a suitable analytical approximation would be intractable. Numerical computation approaches also span a range of feasibility depending on the approach taken and the computational resources available.

As an example of a brute-force numerical approach, it would be possible to use finite element analysis software (e.g., COMSOL Multiphysics, Ansys, or SolidWorks) to numerically solve the thermal diffusion PDE on a fine 3D mesh and perform mathematical optimization. However, this approach requires a great deal of computing power, and even then the computation time would likely exceed the heating process time, meaning that it could not be performed in real-time during a cooking process. Thus, aspects of this disclosure describe approaches that simplify the solutions so that they can be performed in real time, and even on low-cost computing hardware. For instance, identifying parameters a priori may not require high spatial resolution and may be conducted numerically over a sparse grid. As another example, simplification can be obtained by using approximate parameter inference when solving the inverse problem described above. Identification of an optimal control function q(t, x, y) can be simplified by a particular form of the cost function (4) to be derived analytically or approximated heuristically, avoiding potentially numerically intensive application of variational calculus, Pontryagin Principle, or Dynamic Programming.

In particular embodiments of this disclosure, equations (1-6) are discretized on a sparse regular or irregular spatial grid at a series of discrete times. Spatial gradients of the temperature can be approximated as finite differences between the temperatures at adjacent grid points, and evolution of the temperature at each grid point from one time step to the next is calculated according to the thermal diffusion equation using this discretized form of the spatial operators. Spatially varying parameters of the load are discretized as well. For example, evolution of the spatially discretized temperature Tᵢⱼ on the spatial grid xᵢ, yⱼ ∈ [symbol] , i=1, . . . , Nₓ, j=1, . . . , N_{y}, may be calculated as:

Tᵢⱼ^{l+1}−Tᵢⱼ^{l}=Δt( [symbol] [ρᵢⱼ^{l},cᵢⱼ^{l},kᵢⱼ^{l}] [symbol] )ᵢⱼ+Δt\tilde{q}ᵢⱼ^{l+1} (7)

where l=0,1, . . . is a time stepping index, the finite-difference operator L is a discretization of the differential operator

$$\frac{∇ ( k ( T , x , y ) ∇ )}{ρ ( T , x , y ) {c}_{p} ( T , x , y )} , \qquad ( 8 )$$

with finite-difference coefficients as explicitly known functions of the discretized thermal properties

ρᵢⱼ^{l}=ρ(T)(lΔt,xᵢ,yⱼ),cⱼ^{l}=cₚ(T(lΔt,xᵢ,yⱼ),xᵢ,yⱼ),kᵢⱼ^{l}=k(T(lΔt,xᵢ,yⱼ),xᵢ,yⱼ), (9)

and with the discretized source divided by the volumetric heat capacity:

$${\tilde{q}}_{ij}^{m} = \frac{q ( T ( m Δ t , {x}_{i} , {y}_{j} ) , {x}_{i} , {y}_{j} )}{ρ ( T ( m Δ t , {x}_{i} , {y}_{i} ) , {x}_{i} , {y}_{j} ) {c}_{p} ( T ( m Δ t , {x}_{i} , {y}_{j} ) , {x}_{i} , {y}_{j} )} , = 0 , 1 , … \qquad ( 10 )$$

For example, but without limitation, the finite difference operator can be defined as a scaled discretized Laplacian operator

$${( L [ {ρ}_{ij}^{l} , {c}_{ij}^{l} , {k}_{ij}^{l} ] {T}_{∷}^{l + 1} )}_{ij} = \frac{k ( T ( m Δ t , {x}_{i} , {y}_{j} ) , {x}_{i} , {y}_{j} )}{\begin{matrix}ρ ( T ( m Δ t , {x}_{i} , {y}_{j} ) , {x}_{i} , {y}_{j} ) \\ {c}_{p} ( T ( m Δ t , {x}_{i} , {y}_{j} ) , {x}_{i} , {y}_{j} )\end{matrix}} \frac{\begin{matrix}\{ {T}_{i - 1 j}^{l + 1} + {T}_{i + 1 j}^{l + 1} + \\ {T}_{ij - 1}^{l + 1} + {T}_{ij + 1}^{l + 1} - 4 {T}_{ij}^{l + 1} \}\end{matrix}}{{Δ}^{2}} , \qquad ( 11 )$$

over a uniform grid, where ∀i, j: Δ=xᵢ₊₁−xᵢ=yⱼ₊₁−yⱼ=const. The first fraction in the right-hand side of (11) is the coefficient of thermal diffusivity, and all thermal properties may be assumed to vary sufficiently slowly to ignore their spatial derivatives. However, subsequent discussions are equally applicable to other or higher-order discretizations of operator (8). Thus, the above equations 7-11 show one example of how the thermal diffusion PDE Eq. (1) can be discretized and calculated over a sparse grid for numerical computation.

As discussed above, particular embodiments identify any of the parameters of equation (1) that can be known a priori and then measure the initial temperature distribution T(0, xᵢ, yⱼ). As illustrated in step 515 of the example of FIG. 5, particular embodiments subsequently commence operation of the cooking apparatus, applying an initial heating technique where q(t, x, y)=qₘₐₓ=c, where c is a constant (e.g., the maximum energy that can be output by the apparatus). The apparatus continuously collects temperature measurements and captures values T(lΔt, xᵢ, yⱼ), l=0,1, . . . interpolated (or directly measured) over the spatial and temporal grids. This step in the heating process is designed to provide information about the physical properties of the load so that estimates of these properties can be used when numerically solving the heat equation, such as in step 540 of the example method of FIG. 5.

If a temperature maximum Tₘₐₓ is not reached before the load temperature exceeds a user-specified temperature minimum Tₘᵢₙ, particular embodiments continue operating the apparatus with the maximum energy influx until the desired temperature profile T′ₘᵢₙ(x, y)≥T(tₘₐₓ, x, y)≤T′ₘₐₓ(x, y), such as the stopping condition in step 532 of the example of FIG. 5, is reached. (Note that stopping conditions T′ₘᵢₙ(x, y), T′ₘₐₓ(x, y), may be different from Tₘᵢₙ, Tₘₐₓ, which are examples of the temperature limits used in step 525). In the simplest case, a constant (e.g., initial) heating rate yields a user-specified outcome, and an estimated time to completion can be obtained by simple extrapolation given the observed temperature rise and known heating rate.

If Tₘₐₓ is reached before the load temperature exceeds Tₘᵢₙ, this may represent an over-heating scenario and the cooking apparatus adopts a new, optimal heating technique, e.g., q(t, x, y)=qₘᵢₙ=const (e.g., 0). In the case that the maximum temperature is reached and the controller must reduce the heat influx, the evolution of the temperature profile within the load will be influenced strongly by thermal diffusion, and then thermal properties of the load are determined (e.g., as in step 540 of the example of FIG. 5) and used to determine an optimal control strategy (e.g., step 545) and predict thermal evolution of the load (e.g., step 550).

When the heat influx is reduced or paused, particular embodiments utilize collected temperature measurements Tᵢⱼ^{l}=T(lΔt, xᵢ, yⱼ), l=0.1, . . . to estimate the unknown parameters of equation (1) using (for example) regularized least-squares or any other appropriate method of statistical estimation:

$${ρ}_{ij} , {c}_{ij} , {k}_{ij} , {ρ}_{ij}^{′} , {c}_{ij}^{′} , {k}_{ij}^{′} = arg min {\sum }_{l = 0 , 1 , …} {‖ \frac{{T}_{ij}^{l + 1} - {T}_{ij}^{l} - Δ {t ( L [ {ρ}_{ij}^{l} , {c}_{ij}^{l} , {k}_{ij}^{l} ] {T}_{∷}^{l + 1} )}_{ij} - Δ t {\tilde{q}}_{ij}^{l + 1}}{{σ}_{ij}^{l + 1}} ‖}_{2}^{2} + Reg ( {ρ}_{ij} , {c}_{ij} , {k}_{ij} , {ρ}_{ij}^{′} , {c}_{ij}^{′} , {k}_{ij}^{′} ) , \qquad ( 12 )$$

where σᵢⱼ^{l+1} is a measured or estimated standard deviation of thermometric noise. For example,

ρᵢⱼ^{l}=ρᵢⱼ+ρ′ᵢⱼTᵢⱼ^{l};cᵢⱼ^{l}=cᵢⱼ−c′ᵢⱼTᵢⱼ^{l};kᵢⱼ^{l}=kᵢⱼ−k′ᵢⱼTᵢⱼ^{l}. (13)

Instead of the specific representations of (13) that assume a linear dependence on the temperature, particular embodiments utilize alternative parametrized analytical, tabulated, or other empirical functional dependencies of thermal properties on the temperature as well as any other measurable or estimated parameters, properties, or process settings.

The last term in (12) is a linear combination of regularization operators such as, without limitation, minimum norm, Tikhonov, or total-variation regularization of each of the unknowns, that statistically represent prior knowledge of spatial smoothness or variability of properties (9). This regularization term may be included in order to address the possibility that the problem may be ill-posed. Equations (13) express linear variability of thermal properties with temperature, but the approaches described herein apply equally to other forms of thermal variability as well as to temperature-independent properties (e.g., when the primed variables equal 0 in (13)).

Equations (12) and (13) describe in the broad terms the optimization problem that must be solved to infer an estimate of the load's thermal properties from the observed heating rates in the initial phase of the heating process.

For discretization (11), in particular embodiments it is sufficient to estimate only certain combinations of thermal properties: the coefficient of thermal conductivity and volumetric specific heat (see equations (10,11)). At this point, all the coefficients of (7) have been identified, and the optimal control procedure can be commenced. In particular embodiments, the optimal control problem (1-6) is first reduced to the standard form that does not include the continuous state-variable constraints (inequality 5(a)). Particular embodiments introduce a new unknown g=g(x, y) that satisfies the following equation:

$$\frac{\partial g ( t , x , y )}{\partial t} = {( {T}_{max} ( t , x , y ) - T ( t , x , y ) )}^{2} ℍ ( T ( t , x , y ) - {T}_{max} ( t , x , y ) ) + {( T ( t , x , y ) - {T}_{min} ( t , x , y ) )}^{2} ℍ ( {T}_{min} ( t , x , y ) - T ( t , x , y ) ) , \qquad ( 14 )$$

(where [symbol] is the Heaviside function) that is discretized over the temporal-spatial grid lΔt, xᵢ, yⱼ. Equation (14) is supplemented with the 0 boundary conditions:

g(0,x,y)=g(tₘₐₓ,x,y)=0, (15)

and the state-variable constraints 5(a) and 5(b) are replaced with the terminal-time constraints:

T′ₘᵢₙ(x,y)≤T(tₘₐₓ,x,y)≤T′ₘₐₓ(x,y). (16)

Equations (14-16) provide a parallel constraint on the temperature T (t, x, y) in the solution of the optimization equation (4), which finds the optimal heating control strategy. They ensure that the solution keeps the temperature within the prescribed bounds. Note that the right-hand side of Eq. (14) is non-negative, so given the boundary conditions in Eq. (15), g (x, y)=0 by necessity throughout the process. In this manner, particular embodiments assume that tₘₐₓ is unknown and q(t, x, y) is the control variable, and optimize the cost functional (4) under the constraints in equations (1), (2), (3), (14), (15), (16). This optimal solution to Eq. (4) can be derived from techniques such as Potryagin Principle or Dynamic Programming. The functional (4) and all constraints discretize over the temporal-spatial grid lΔt, xᵢ, yⱼ.

In particular embodiments, solving the optimal control problem implies solving for the unknown total heating time tₘₐₓ, optimal heat input q(t, x, y)=qₒₚₜ(t, x, y), and predicted load temperature distribution T(t, x, y)=T_{pred}(t, x, y). The result is converted to an ETC and reported to the user in real time. As illustrated in the example of FIG. 5, in particular embodiments operation of the apparatus under the optimal control qₒₚₜ(t, x, y) resumes, and the procedure repeats if a significant deviation is detected between the measured and predicted T(t, x, y) or if a predetermined thermal condition is met.

In particular embodiments, state-variable (load temperature) constraints (16) are of the form:

T(t,x,y)≤Tₘₐₓ=const,t∈[0,tₘₐₓ);T(tₘₐₓ,x,y)≥T′ₘᵢₙ=const (17)

equivalent to:

$${max}_{x , y} T ( t , x , y ) \leq {T}_{max} , t ∈ [ 0 , {t}_{max} ) ; \qquad ( 18 )$$

$${min}_{x , y} , T ( {t}_{max} , x , y ) \geq {T}_{min}^{′} = const$$

These constraints express the requirement that the load temperature is not to exceed a certain maximum temperature threshold (e.g., the temperature at which unintentional parcooking may occur), and that the final load temperature is everywhere above a certain minimum temperature threshold (e.g., as required for adequate thawing of a frozen load). In this and other embodiments where the state-variable constraints can be expressed in terms of spatially uniform quantities such as maximum, minimum, or average values, the optimal or near-optimal strategy q(t, x, y)=qₒₚₜ(t, x, y) may be defined explicitly as an adaptive algorithm. For example, minimizing the total process time would specify function F in the cost functional Eq. (4) as follows:

=J=∫₀^{t}^{ₘₐₓ}∫∫ [symbol] | [symbol] |⁻¹·dxdy dt=tₘₐₓ, (19)

where | [symbol] | is the area of the fixed domain [symbol] , under the state-variable (temperature) constraints (18). Particular embodiments may then use the following control strategy:

$${q}_{opt} ( t = 0 , x , y ) = {q}_{max} , ∀ t > 0 : {q}_{opt} ( t , x , y ) = {q}_{opt} ( t ) = \{ \begin{matrix}\begin{matrix}{q}_{min} if {max}_{x , y} T ( t , x , y ) > {T}_{max} , \\ {q}_{max} if {max}_{x , y} T ( t , x , y ) < {T}_{on} ,\end{matrix} \\ {q}_{opt} ( t - 0 ) otherwise ( i . e . , keep previous setting )\end{matrix} , \qquad ( 20 )$$

where Tₒₙ<Tₘₐₓ is a user-specified or system-specified (e.g., as a percentage of Tₘₐₓ) temperature that triggers switching the apparatus back to the “full power” mode. The control strategy described in (20) is a simple example of an on-off control strategy in which heat is applied until overheating is observed, at which point the heat influx is decreased to qₘᵢₙ (which may be zero) until the load cools sufficiently through thermal diffusion. In particular embodiments, as illustrated in the example of FIGS. 3A and 3B, qₘₐₓ if

$${max}_{x , y} T ( t , x , y ) < {T}_{on}$$

may instead be qₕ if

$${max}_{x , y} T ( t , x , y ) < {T}_{on} ,$$

where qₕ is a user-specified or system-specified heating value between the maximum and minimum possible heating values. Likewise, in particular embodiments, qₘᵢₙ if

$${max}_{x , y} T ( t , x , y ) > {T}_{max}$$

may instead be qₛ if

$${max}_{x , y} T ( t , x , y ) > {T}_{max} ,$$

where qₛ, is a user-specified or system-specified heating value between the maximum and minimum heating values, and qₛ<qₕ. In particular embodiments, the value of qₕ and/or qₛ may be based on a heating mode of the apparatus (e.g., defrost, cook, broil, sear, etc.). In particular embodiments, this approach does not solve Eq. (4) to find the optimal control sequence. Instead, it uses equation (20), which describes an “on-off” control: the input heat is qₘₐₓ (or qₕ) as long as the load temperature is within bounds, and qₘᵢₙ (potentially zero, or qₛ) if any part of the load exceeds Tₘₐₓ.

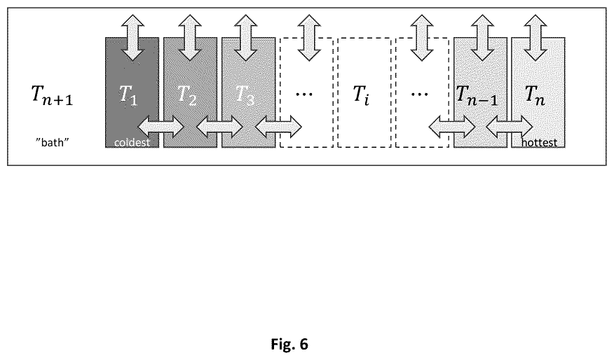

Particular embodiments may use a simplified heat-exchanger model for implementing aspects of this disclosure on minimal (e.g., microcontroller) hardware. In particular embodiments, predicting aggregate temperature measures such as minimum, maximum, or quantile temperatures may not require accurate solution of the full heat diffusion equation (1) or its discretization (7), even over a very sparse grid. Such embodiments may therefore use a heat exchanger model to simulate the evolution of such discrete measures. An example heat-exchanger model is illustrated in FIG. 6. This example uses n+1 (n≥3) linear elements that may represent thermal properties, such as minimum, maximum, or respective quantiles of the load temperature, immersed in a hypothetical “bath” that represents a plate or microwave turntable. For example, but without limitation, if n=3, the exchanger elements represent the following temperature measures:

T₁(t)≈ [symbol] T(t,x,y)dxdy,T₂(t)≈ [symbol] T(t,x,y)dxdy, T₃(t)≈ [symbol] T(t,x,y)dxdy,T₄(t)≈ [symbol] T(t,x,y)dxdy, (21)

where the areas of integration are specified by zones [symbol] , [symbol] , [symbol] , and [symbol] , where [symbol] and [symbol] are neighborhoods of the locations of maximum and minimum temperature readings, [symbol] represents the load, and [symbol] is the domain (e.g., a plate, turntable, rack, tray, etc.), which effectively acts as a thermal bath to the load. As such, in this example T₁ represents the temperature averaged over the coldest region of the load, T₂ the medium-temperature part of the load, T₃ the hottest region of the load, and T₄ is the average temperature of the surrounding plate or turntable. As a result, as the example of FIG. 6 illustrates, these embodiments reduce the full two-dimensional discretization of the thermal diffusion equation to a series of rate equations for mean temperatures in a number of (e.g, four or more) spatial “zones”. These zones do not necessarily have the same area or perimeter, nor do the areas associated with each zone necessarily need to be spatially contiguous, which means that thermal diffusion among them will need to be described phenomenologically. The evolution of the temperatures due to heat exchange among the zones may be described as follows:

Tᵢ^{l+1}−Tᵢ^{l}=αᵢ₋₁(Tᵢ₋₁^{l+1}−Tᵢ^{l+1})+αᵢ(Tᵢ₊₁^{l+1}−Tᵢ^{l+1})+βᵢ(Tₙ₊₁^{l+1}−Tᵢ^{l+1})+γᵢq^{l+1}, i+1,2, . . . , n; l=0, 1, . . . (22)

Tₙ₊₁^{l+1}−Tₙ₊₁^{l}=Σᵢ₌₁ⁿβᵢ(Tᵢ^{l+1}−Tₙ₊₁^{l+1})+γₙ₊₁q^{l+1}, (23)

α₀=αₙ=0,T_{:}^{l}=T_{:}(lΔt), q^{l}=q(lΔt). (24)

Equation (22) can be expressed in a vector form like (7):

Tᵢ^{l+1}−Tᵢ^{l}=( [symbol] ′[α_{:}, β_{:}]T_{:}^{l+1})i+γᵢq^{l+1},i=1,2, . . . ,n+1, (25)

where the coefficients of operator [symbol] ′ are linear combinations of αᵢ, βᵢ. The coefficients αᵢ, βᵢ, represent generalized “heat diffusion” coefficients multiplied by the time step—in other words, αᵢ and βᵢ correspond to the coefficient of thermal diffusivity in Eq. (11). More specifically, αᵢi=1,2, n−1 describes heat exchange between the load elements described by Tᵢ, Tᵢ₊₁ in FIG. 6, while βᵢ, i=1,2, n describes the exchange between a load element with Tᵢ and the bath at temperature Tₙ₊₁. The coefficients γᵢ, i=1,2, . . . , n+1 can be thought of as determined by the “volumetric capacitance” of each element and the bath, effectively incorporating the information that ρ and cₚ do in Eq. (11).

Reparametrizing Eqs. (711) by “hyperparameters” αᵢ, βᵢ and γᵢ may be necessary because the aggregate state variables Tᵢ no longer represent temperatures measured at discrete spatial points. We cannot trivially calculate the change in temperature Tᵢ within one region due to surrounding temperatures Tᵢ₋₁, Tᵢ₊₁, etc. according to the spatial discretization of Eq. (7), because we have eliminated spatial information from the problem. The different regions within the load are diffusively connected, but in a nontrivial way that will require observation of the temperature evolution and fitting of the hyperparameters based on the observed data.

The coefficients αᵢ, βᵢ, γᵢ are unknown but can be estimated from thermometric

observations using, without limitation, a statistical inference approach like (12):

$${α}_{i} , {β}_{i} , {γ}_{i} = arg min {\sum }_{l = 0 , 1 , …} {‖ \frac{{T}_{i}^{l + 1} - {T}_{i}^{l} - {( {L}^{′} [ {α}_{:} , {β}_{:} ] {T}_{:}^{l + 1} )}_{i} - {γ}_{i} {q}^{l + 1}}{{σ}_{i}^{l + 1}} ‖}_{2}^{2} + Reg ( {α}_{i} , {β}_{i} , {γ}_{i} ) . \qquad ( 26 )$$

In (26), Tᵢ^{l} are aggregate measures derived from temperature measurements e.g., using domain segmentation and expressions (21), σᵢ^{l+1} is a measured or estimated standard deviation of the corresponding aggregate temperature measures, and the last term represents an optional regularization prior, such as a minimum vector norm. As in Eq. (12), the regularization prior is used to facilitate solution of an inverse problem that might otherwise be ill-posed. Note that problem (26) could be significantly easier to solve numerically than (12). For example, for n=3 we estimate only 9 parameters: α_{1,2}, β_{1,2,3}, γ_{1,2,3,4}, whereas Eq. (12) is calculated over all discretized points within the field of view of the temperature measurement. Equation (26) therefore describes mathematically how the hyperparameters in Eqs. (22-25) are determined from observed data, in particular embodiments.

As one example, the 9 parameters α_{1,2}, β_{1,2,3}, γ_{1,2,3,4} may be estimated using least-squares fitting (26) (with σ₁^{l}=1, Reg=∈(| [symbol] |²+| [symbol] |²+| [symbol] |²) to the aggregate measures (21) computed for an initial time period (e.g., 200 seconds) of observations. Temporal smoothing may be applied to the data prior to the fitting.

In particular embodiments, a temperature map may be accessed or created periodically, e.g., every few seconds, or more or less, during a cooking process. In particular embodiments, updates to a heating technique or to thermal-property estimation or prediction, or any combination therefore, may be performed periodically, for example a few times a minute, or more or less.

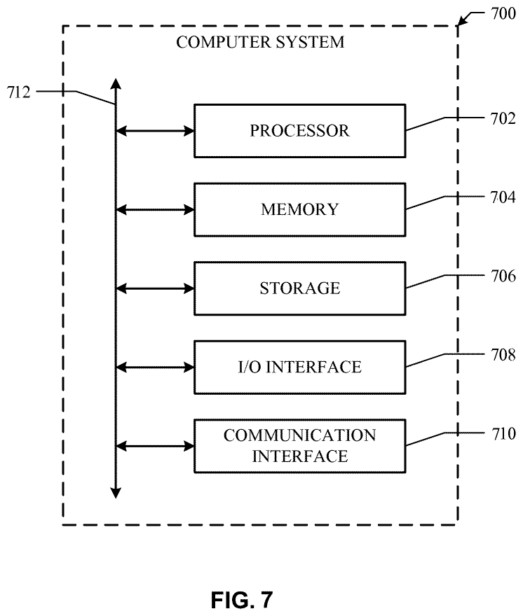

Particular embodiments may repeat one or more steps of the methods of FIGS. 1 and 5, where appropriate. Although this disclosure describes and illustrates particular steps of the methods of FIGS. 1 and 5 as occurring in a particular order, this disclosure contemplates any suitable steps of the method of FIG. 1 or 5 occurring in any suitable order. Moreover, although this disclosure describes and illustrates particular components, devices, or systems carrying out particular steps of the methods of FIGS. 1 and 5, such as the computer system of FIG. 7, this disclosure contemplates any suitable combination of any suitable components, devices, or systems carrying out any suitable steps of the methods of FIGS. 1 and 5. Moreover, this disclosure contemplates that some or all of the computing operations described herein, including the steps of the example methods illustrated in FIGS. 1 and 5, may be performed by circuitry of a computing device, for example the computing device of FIG. 7, by a processor coupled to non-transitory computer readable storage media, or any suitable combination thereof

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
accessing a temperature map of a food item in a cooking apparatus, wherein the temperature map comprises a plurality of regions of the food item and associates a temperature with each region, and wherein the cooking apparatus cooks according to an initial heating technique;
determining, by a computing device, whether a temperature associated with at least one region of the food item violates a predetermined temperature constraint;
in response to a determination that the temperature associated with at least one region of the food item violates the predetermined temperature constraint, then determining an optimal heating technique and instructing the cooking apparatus to cook according to the optimal heating technique; and
in response to a determination that the temperature of each region does not violate the predetermined temperature constraint, then determining that the initial heating technique should not be changed.

2. The method of claim 1, further comprising:
accessing a thermal image of the food item in the cooking apparatus; and
creating the temperature map based on the thermal image.

3. The method of claim 1, wherein the initial heating technique comprises heating according to a maximum heating mode of the cooking apparatus.

4. The method of claim 1, further comprising:
determining, based on the temperature map, whether the food item has reached a predetermined target temperature;
in response to a determination that the food item has not reached the predetermined target temperature, then re-executing the steps of claim 1; and
in response to a determination that the food item has reached the predetermined target temperature, then instructing the cooking apparatus to cease cooking the food item.

5. The method of claim 4, wherein:
the predetermined target temperature comprises a minimum temperature; and
determining whether the food item has reached the predetermined target temperature comprises determining whether every region of the food item has reached the minimum temperature.

6. The method of claim 5, wherein a value of the minimum temperature is based on a cooking mode of the cooking apparatus.

7. The method of claim 1, wherein the predetermined temperature constraint comprises one or more of:
a maximum temperature; or
a predicted temperature.

8. The method of claim 7, wherein determining, by a computing device, whether the temperature associated with at least one region of the food item violates a predetermined temperature constraint comprises:
determining whether the temperature associated with at least one region of the food item exceeds the maximum temperature; or
determining whether the temperature associated with at least one region of the food item differs from a predicted temperature for that region by at least a predetermined threshold amount.

9. The method of claim 1, wherein the optimal heating technique comprises heating the food item according to a minimum heating mode of the cooking apparatus.

10. The method of claim 1, further comprising estimating one or more thermal properties of the food item.

11. The method of claim 10, wherein determining the optimal heating technique comprises:
predicting, based on the estimated thermal properties of the food item, a thermal evolution of the food item over time; and
determining, based on the predicted thermal evolution of the food item over time, the optimal heating technique.

12. The method of claim 11, wherein predicting the thermal evolution of the food item over time comprises predicting, based on the estimated thermal properties of the food item, a temperature evolution of the food item over time.

13. The method of claim 12, further comprising:
determining that an observed temperature evolution of the food item differs from the predicted temperature evolution of the food item by a predetermined amount;
in response to the determination that the observed temperature evolution of the food item differs from the predicted temperature of the food item by a predetermined amount, then updating the estimate of the one or more thermal properties of the food item; and
updating the optimal heating technique based on the updated estimate of the thermal properties of the food item.

14. The method of claim 11, wherein determining, based on the predicted thermal evolution of the food item over time, the optimal heating technique comprises minimizing a cost function for a thermal property of the food item, wherein the cost function is at least in part a function of an amount of thermal energy provided by the cooking apparatus.

15. The method of claim 14, further comprising minimizing the cost function subject to at least one of: (1) one or more thermal constraints or (2) one or more constraints on one or more control variables that define a heating technique.

16. The method of claim 15, wherein the one or more thermal constraints comprise:
a minimum temperature that each region of the food item must exceed; and
a maximum temperature that each region of the food item must not exceed.

17. The method of claim 14, wherein the thermal property comprises a completion time for cooking the food item.

18. The method of claim 10, wherein:
estimating one or more thermal properties of the food item comprises estimating a completion time for cooking the food item; and
the method further comprises providing, for display to a user, the estimated completion time for cooking the food item.

19. The method of claim 10, wherein estimating one or more thermal properties of the food item comprises predicting, using a heat-exchanger model comprising a plurality of zones that are each defined by an associated temperature range, one or more aggregate temperature measures for at least a portion of the food item.

20. One or more non-transitory computer readable storage media embodying instructions and coupled to one or more processors that are operable to execute the instructions to:
access a temperature map of a food item in a cooking apparatus, wherein the temperature map comprises a plurality of regions of the food item and associates a temperature with each region, and wherein the cooking apparatus cooks according to an initial heating technique;
determine, by a computing device, whether a temperature associated with at least one region of the food item violates a predetermined temperature constraint;
in response to a determination that the temperature associated with at least one region of the food item violates the predetermined temperature constraint, then determine an optimal heating technique and instruct the cooking apparatus to cook according to the optimal heating technique; and
in response to a determination that the temperature of each region does not violate the predetermined temperature constraint, then determine that the initial heating technique should not be changed.

21. A system comprising one or more processors and a non-transitory computer readable storage media embodying instructions coupled to the one or more processors, the one or more processors operable to execute the instructions to:
access a temperature map of a food item in a cooking apparatus, wherein the temperature map comprises a plurality of regions of the food item and associates a temperature with each region, and wherein the cooking apparatus cooks according to an initial heating technique;
determine, by a computing device, whether a temperature associated with at least one region of the food item violates a predetermined temperature constraint;
in response to a determination that the temperature associated with at least one region of the food item violates the predetermined temperature constraint, then determine an optimal heating technique and instruct the cooking apparatus to cook according to the optimal heating technique; and
in response to a determination that the temperature of each region does not violate the predetermined temperature constraint, then determine that the initial heating technique should not be changed.
